(19) United States
(12) Patent Application Publication
(10) Pub. No.: US 2011/0254954 A1
(43) Pub. Date: Oct. 20, 2011

(54) APPARATUS AND METHOD FOR AUTOMATICALLY ADJUSTING POSITIONS OF MICROPHONE

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/860,920

(22) Filed: Aug. 22, 2010

(30) Foreign Application Priority Data
Apr. 14, 2010 (TW) 99111684

(51) Int. Cl. H04N 7/18

(52) U.S. Cl. 348/142; 348/E07.085

(57) ABSTRACT

An apparatus and method automatically adjusts a current position of a microphone to a voice reception position for receiving optimal voices from a speaker. A scene image in front of the microphone is captured by an image capturing unit of the apparatus at a predetermined interval. The apparatus analyzes the scene image to determine whether the scene image includes a face image of the speaker, and detects a position of a mouth of the speaker based on the face image. The voice reception position is calculated according to the position of the mouth of the speaker and a standard position stored in a storage system. A driving command is generated to control a driver to adjust the current position of the microphone to the voice reception position.

### BACKGROUND

1. Technical Field

Embodiments of the present disclosure relate generally to controlling microphones, and more particularly to an apparatus and method for automatically adjusting positions of a microphone.

2. Description of Related Art

Vertically adjustable microphone stands typically utilize a rotatable clutch which is secured to a upper section of a microphone. In order to adjust height of the microphone, it is necessary to use both hands to loosen the clutch, raise or lower the upper section, and then retighten the clutch.

There are several disadvantages associated with these manually adjustable microphone stands. For example, because two hands are required to adjust the height, a user must typically bend over while loosening or tightening the clutch, thereby making it difficult to determine an acceptable position for the microphone to receive the voice of the user. In addition, the clutch may become loose when the microphone is adjusted.

### BRIEF DESCRIPTION OF THE DRAWINGS

FIG. 1 is a schematic diagram of one embodiment of a microphone adjustment apparatus.

FIG. 2 shows a schematic diagram illustrating one example of installation of a microphone.

FIG. 3 is a flowchart of one embodiment of a method for adjusting positions of a microphone using the apparatus of FIG. 1.

FIG. 4 shows a schematic diagram illustrating one example of executing an automatic mode of the apparatus.

FIG. 5 shows a schematic diagram illustrating one example of executing a user-defined mode of the apparatus.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

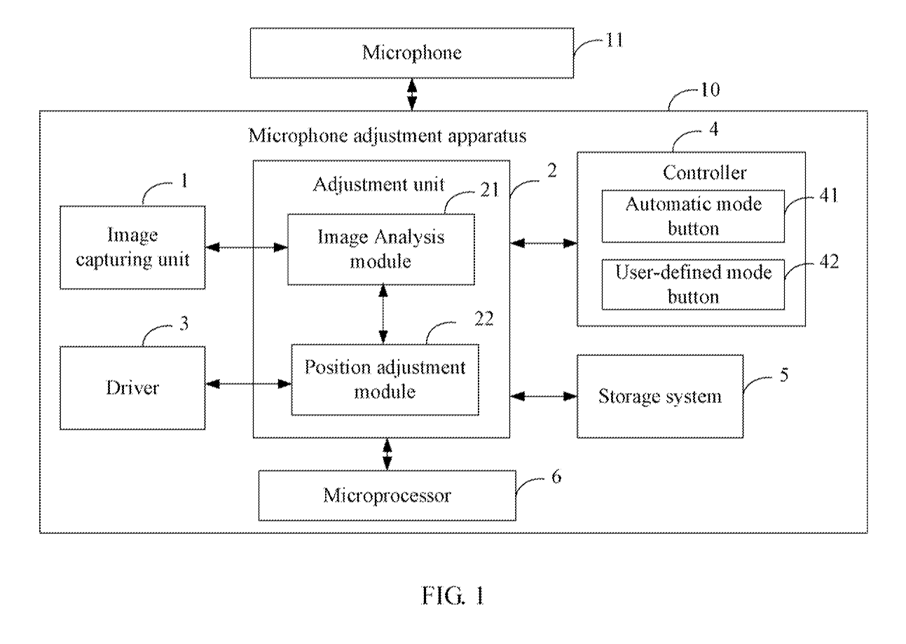

FIG. 1 is a schematic diagram of one embodiment of a microphone adjustment apparatus 10. In the embodiment, the apparatus 10 can automatically adjust a current position of the microphone 11 to a voice reception position of the microphone 11 when the microphone 11 receives voices from a speaker. As used herein, the term “voice reception position” is defined as a position that allows the microphone 11 to optimize voice reception from the speaker, and includes a height of the microphone 11, a direction of microphone 11 towards a mouth of the speaker, and a distance between the microphone 11 and the mouth of the speaker.

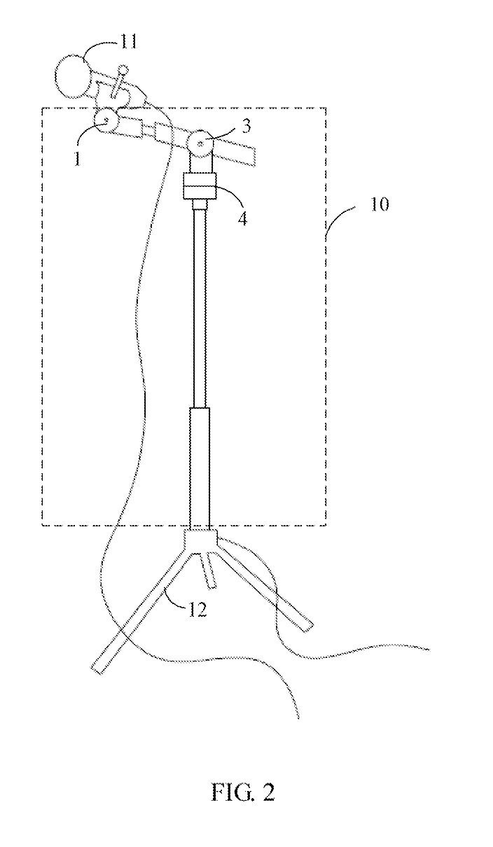

In one embodiment, the microphone adjustment apparatus 10 includes an image capturing unit 1, an adjustment unit 2, a driver 3, and a controller 4. The microphone adjustment apparatus 10 may further include a storage system 5 and at least one microprocessor 6. In one example with respect to FIG. 2, the microphone adjustment apparatus 10 is positioned on a base member 12, and the microphone 11 is located at the microphone adjustment apparatus 10. Each of the components 1-6 may embedded in the base member 12. It should be apparent that FIG. 1 illustrates only one example of the microphone adjustment apparatus 10, and may include more or fewer components than illustrated, or a different configuration of the various components in other embodiments.

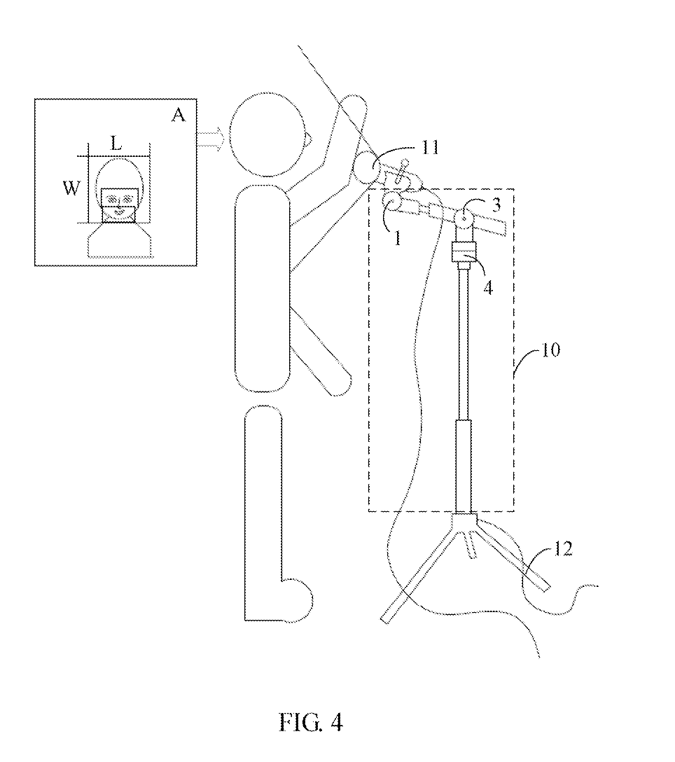

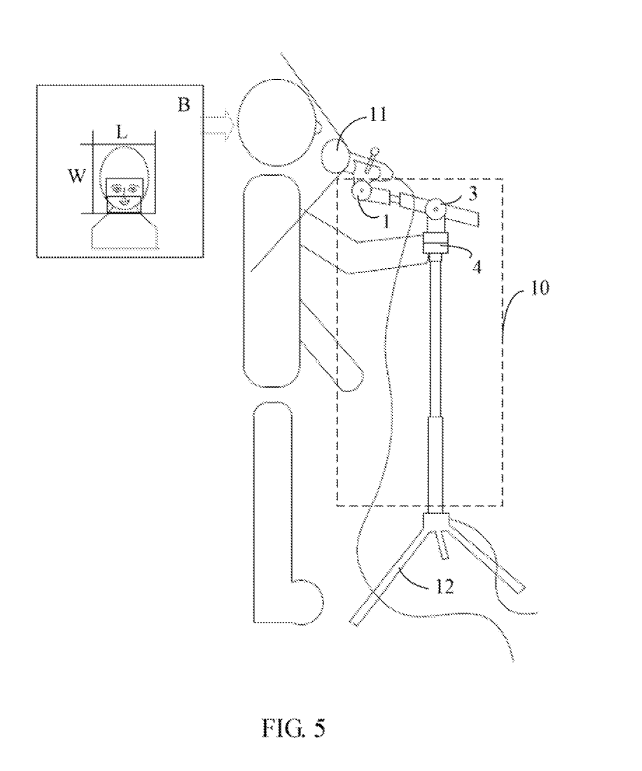

The controller 4 includes an automatic mode button 41 and a user-defined mode button 42. Referring to FIG. 4, the controller 4 invokes an automatic mode when the automatic mode button 41 is pressed. Referring to FIG. 5, the controller 4 invokes a user-defined mode when the user-defined mode button 42 is pressed. In one embodiment, the automatic mode is defined as a first operation mode that the microphone adjustment apparatus 10 adjusts the voice reception position of the microphone 11 based on a standard parameter pre-stored in the storage system 5. The standard parameter may be preset by a manufacturer of the microphone 11 according to a height of the speaker, such as 1.7 meters, for example. The user-defined mode is defined as a second operation mode that the microphone adjustment apparatus 10 adjusts the voice reception position of the microphone 11 based on a user-defined parameter. The user-defined parameter is set by the speaker through the user-defined mode button 42.

The image capturing unit 1 may be a digital camera or a video camera capable of capturing digital images. In the embodiment, the image capturing unit 1 captures one or more images of a scene (hereinafter, “scene images”) in front of the microphone 11, such as the image “A” as shown in FIG. 4 or the image “B” as shown in FIG. 5, and sends to the scene images to the an adjustment unit 2 for analysis.

The adjustment unit 2 may include a plurality of functional modules including one or more computerized instructions that are stored in the storage system 5. The storage system 5 may be an internal storage device, such as a random access memory (RAM) for temporary storage of information, and/or a read only memory (ROM) for permanent storage of information. The storage system 5 may also be an external storage device, such as a hard disk, a storage card, or a data storage medium.

In one embodiment, the adjustment unit 2 includes an image analysis module 21, and a position adjustment module 22. One or more computerized codes of the function modules 21, 22 may be stored in the storage system 5 and executed by the at least one processor 6. In general, the word “module,” as used herein, refers to logic embodied in hardware or firmware, or to a collection of software instructions, written in a programming language. The software instructions in the modules may be embedded in firmware, such as an erasable programmable read only memory (EPROM). The modules described herein may be implemented as either software and/or hardware modules and may be stored in any type of computer-readable medium or other storage device.

The image analysis module 21 controls the image capturing unit 1 to capture a scene image in front of the microphone 11 at a predetermined interval, such as every one or two seconds, for example. The image analysis module 21 further analyzes the scene image to determine whether the scene image includes a face image of the speaker. When the face image is detected in the scene image, the image analysis module 21 is further operable to detect a position of the mouth of the speaker based on the face image. In one example with respect to FIG. 4, the face image may be a rectangle having a length scale “L” and a width scale “W”.

The position of the mouth of the speaker in the face image may be defined as an intersection between one-second of the length scale (i.e., ½*L) and two-thirds of the width scale (i.e., ⅔*W).

The position adjustment module 22 is operable to calculate the voice reception position of the microphone 11 according to the position of the mouth of the speaker and the standard parameter stored in the storage system 5. The position adjustment module 22 is further operable to generate a driving command for controlling the driver 3 to adjust a current position of the microphone 11 to the voice reception position, thereby the microphone 11 can receive the optimal voices from the speaker based upon the voice reception position. In the embodiment, the driver 3 may be a device that can be used to automatically adjust the current position of the microphone 11 to the voice reception position.

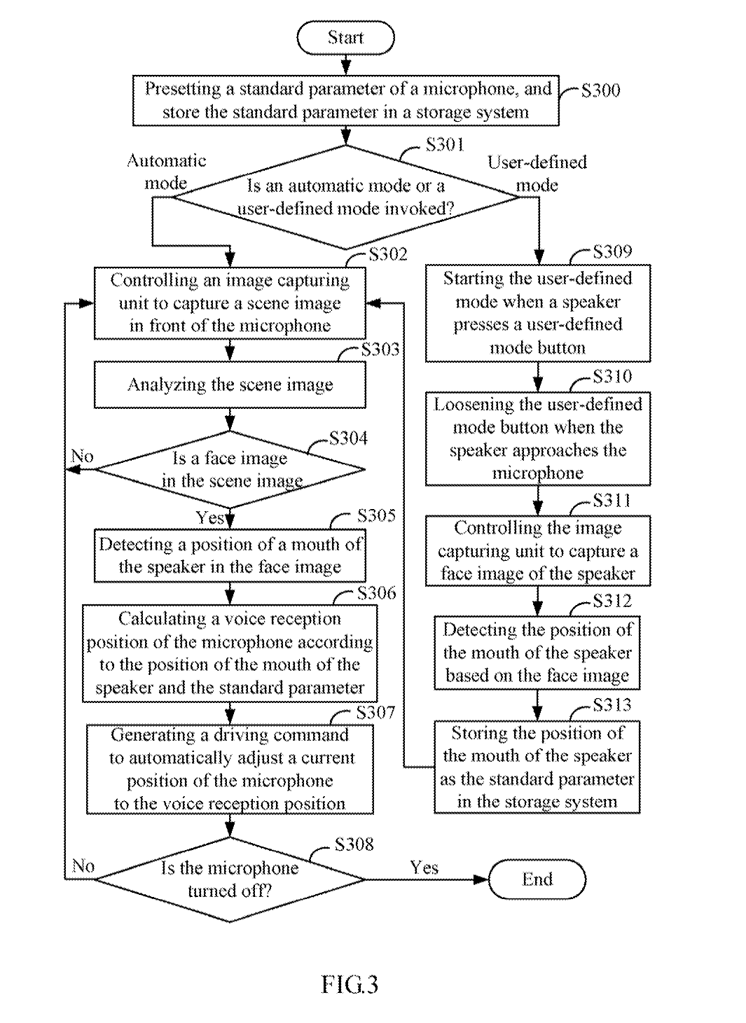

FIG. 3 is a flowchart of one embodiment of a method for adjusting positions of a microphone using the apparatus 10 of FIG. 1. In the embodiment, the method can automatically adjust a voice reception position of the microphone 11 for receiving optimal voices from a speaker. Depending on the embodiment, additional blocks may be added, others removed, and the ordering of the blocks may be changed.

In block S300, a manufacturer of the microphone 11 presets a standard parameter of the microphone 11, and stores the standard parameter in the storage system 5. In one embodiment, the standard parameter may be preset by the manufacturer according to a height of the speaker, such as 1.7 meters, for example.

In block S301, the controller 4 determines whether an automatic mode or a user-defined mode of the microphone 11 is invoked. As mentioned above, the controller 4 invokes an automatic mode when the automatic mode button 41 is pressed, and invokes a user-defined mode when the user-defined mode button 42 is pressed. If the automatic mode is invoked, block S302 is implemented. If the user-defined mode is invoked, block S309 is implemented.

In block S302, the image capturing unit 1 captures a scene image in front of the microphone 11 at a predetermined interval, such as every one or two seconds, for example. In block S303, the image analysis module 21 analyzes the scene image captured from the image capturing unit 1. In block S304, the image analysis module 21 determines whether the scene image includes a face image of the speaker. If the scene image includes a face image of the speaker, block S305 is implemented. Otherwise, if the scene image does not include a face image of the speaker, block S302 is repeated.

In block S305, the image analysis module 21 detects a position of the mouth of the speaker based on the face image when the face image is detected in the scene image. In one example with respect to FIG. 4, the face image may be a rectangle having a length scale “L” and a width scale “W”. The position of the mouth of the speaker in the face image may be defined as an intersection between one-second of the length scale (i.e., ½*L) and two-thirds of the width scale (i.e., ⅔*W).

In block S306, the position adjustment module 22 calculates a voice reception position of the microphone 11 according to the position of the mouth of the speaker and the standard parameter stored in the storage system 5. In one embodiment, the voice reception position may include a height of the microphone 11, a direction of the microphone 11 towards the mouth of the speaker, and a distance between the microphone 11 and the mouth of the speaker.

In block S307, the position adjustment module 22 generates a driving command, and sends the driving command to the driver 3 to automatically adjust a current position of the microphone 11 to the voice reception position, thereby the microphone 11 can receive optimal voices from the speaker based upon the voice reception position.

In block S308, the controller 4 determines whether the microphone 11 is turned off. If the microphone 11 is not turned off, block S302 is repeated. Otherwise, if the microphone 11 is turned off, the flow ends.

In block S309, the controller 4 executes the user-defined mode when the speaker presses the user-defined mode button 42. In block S310, the user loosens the user-defined mode button 42 when the face of the speaker approaches to the microphone 11. In block S311, the image analysis module 21 controls the image capturing unit 1 to capture a face image of the speaker. In block S311, the image analysis module 21 detects a position of the mouth of the speaker based on the face image, and regards the position of the mouth of the speaker as a user-defined standard parameter. In block S310, the image analysis module 21 stores the user-defined parameter in the storage system 5 to replace the preset standard parameters, and the flow goes to block S302 as described above.

In one embodiment, the image capturing unit 1 may capture the scene images at different predetermined intervals. The adjustment unit 2 may adjust the microphone 11 to different voice reception positions by analyzing the scene images captured at different times. Therefore, the microphone adjustment apparatus and method can timely adjust a proper voice reception position of the microphone 11 for receiving optimal voices from the speaker, even the speaker slightly swings the head or moves the body using the microphone 11.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An apparatus for adjusting a position of a microphone, the apparatus comprising:
an image capturing unit;
an image analysis module operable to control the image capturing unit to capture a scene image in front of the microphone at a predetermined interval, determine whether the scene image includes a face image of a speaker, and detect a position of a mouth of the speaker based on the face image; and
a position adjustment module operable to calculate a voice reception position of the microphone according to the position of the mouth of the speaker and a parameter stored in the storage system, and control a driver to automatically adjust a current position of the microphone to the voice reception position.

2. The apparatus according to claim 1, further comprising a controller that comprises an automatic mode button for invoking an automatic mode of the controller.

3. The apparatus according to claim 2, wherein the controller further comprises a user-defined mode button for invoking a user-defined mode of the controller.

4. The apparatus according to claim 1, wherein the voice reception position comprises a height of the microphone, a direction of microphone towards the mouth of the speaker, and a distance between the microphone and the mouth of the speaker.

5. The apparatus according to claim 1, wherein the parameter is a standard parameter preset by a manufacture or a user-defined parameter defined by the speaker.

6. A method for adjusting a position of a microphone, the method comprising:
(a1) presetting a standard parameter of the microphone, and storing the standard parameter in a storage system;
(a2) controlling an image capturing unit to capture a scene image in front of the microphone at a predetermined interval;
(a3) determining whether the scene image includes a face image of a speaker;
(a4) detecting a position of a mouth of the speaker based on the face image when the face image is detected in the scene image;
(a5) calculating a voice reception position of the microphone according to the position of the mouth of the speaker and the standard parameter stored in the storage system; and
(a6) generating a driving command, and sending the driving command to a driver to automatically adjust a current position of the microphone to the voice reception position.

7. The method according to claim 6, further comprising:
determining whether an automatic mode or a user-defined mode of a controller is invoked, wherein the controller comprises an automatic mode button and a user-defined button;
in response to the automatic mode, executing block (a2) to block (a6);
in response to the user-defined mode, executing block (b1) to block (b4):
(b1) controlling the image capturing unit to capture the face image of the speaker;
(b2) detecting the position of the mouth of the speaker based on the face image;
(b3) regarding the position of the mouth of the speaker as a user-defined parameter; and
(b4) storing the user-defined parameter to replace the standard parameter stored in the storage system, and repeating from block (a2) to block (a6).

8. The method according to claim 7, wherein the automatic mode is invoked when the automatic mode button is pressed.

9. The method according to claim 7, wherein the user-defined mode is invoked when the user-defined mode button is pressed.

10. The method according to claim 6, wherein the voice reception position comprises a height of the microphone, a direction of microphone towards the mouth of the speaker, and a distance between the microphone and the mouth of the speaker.

11. The method according to claim 6, wherein the position of the mouth of the speaker in the face image is defined as an intersection between one-second of the length scale of the face image and two-thirds of the width scale of the face image.

12. A storage medium having stored thereon instructions that, when executed by a least one processor of an apparatus, causes the apparatus to perform a method for adjusting a position of a microphone, the method comprising:
(a1) presetting a standard parameter of the microphone, and storing the standard parameter in a storage system;
(a2) controlling an image capturing unit to capture a scene image in front of the microphone at a predetermined interval;
(a3) determining whether the scene image includes a face image of a speaker;
(a4) detecting a position of a mouth of the speaker based on the face image when the face image is detected in the scene image;
(a5) calculating a voice reception position of the microphone according to the position of the mouth of the speaker and the standard parameter stored in the storage system; and
(a6) generating a driving command, and sending the driving command to a driver to automatically adjust a current position of the microphone to the voice reception position.

13. The storage medium according to claim 12, wherein the method further comprises:
determining whether an automatic mode or a user-defined mode of a controller is invoked, wherein the controller comprises an automatic mode button and a user-defined button;
in response to the automatic mode, executing block (a2) to block (a6);
in response to the user-defined mode, executing block (b1) to block (b4):
(b1) controlling the image capturing unit to capture the face image of the speaker;
(b2) detecting the position of the mouth of the speaker based on the face image;
(b3) regarding the position of the mouth of the speaker as a user-defined parameter; and
(b4) storing the user-defined parameter to replace the standard parameter in the storage system, and repeating from block (a2) to block (a6).

14. The storage medium according to claim 13, wherein the automatic mode is invoked when the automatic mode button is pressed.

15. The storage medium according to claim 13, wherein the user-defined mode is invoked when the user-defined mode button is pressed.

16. The storage medium according to claim 12, wherein the voice reception position comprises a height of the microphone, a direction of microphone towards the mouth of the speaker, and a distance between the microphone and the mouth of the speaker.

17. The storage medium according to claim 12, wherein the position of the mouth of the speaker in the face image is defined as an intersection between one-second of the length scale of the face image and two-thirds of the width scale of the face image.
